(19) United States
(12) Patent Application Publication
(10) Pub. No.: US 2019/0331096 A1
(43) Pub. Date: Oct. 31, 2019

(54) Directional Motive Force Generation Device

(71) Applicant: Richard Lauch, Linden, NJ (US)

(72) Inventor: Richard Lauch, Linden, NJ (US)

(21) Appl. No.: 16/445,504

(22) Filed: Jun. 19, 2019

Related U.S. Application Data
(63) Continuation of application No. 15/347,123, filed on Nov. 9, 2016.
Application No. 15/347,123 is a continuation of application No. 14/290,456, filed on May 29, 2014, now abandoned.

(51) Int. Cl. F03G 3/00

(52) U.S. Cl. CPC F03G 3/00; Y10T 74/18528

(57) ABSTRACT

A motive force generation device for generating a net resultant propulsive force vector through reactionless drive means. The device includes a reactionless drive that rotates one or more masses about an axis, decreases the radius about the axis without causing external torque on the system therefore increasing the energy level of the mass, continues to rotate mass at the higher energy level, then increases the radius about the axis to its original distance. The work required to rotate mass at a higher energy state is greater than the work to rotate mass at the original state, causing an unbalanced system resulting in the net propulsive force.

### CROSS-REFERENCE TO RELATED APPLICATIONS

This application is a continuation of U.S. nonprovisional patent application Ser. No. 15/347,123, filed Nov. 9, 2016, which is a continuation of U.S. nonprovisional patent application Ser. No. 14/290,456, filed May 29, 2014.

### STATEMENT REGARDING FEDERALLY SPONSORED RESEARCH OR DEVELOPMENT

The federal government may have certain rights to the invention under U.S. Army Regulation AR27-60.

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

The present invention relates to mechanical propulsion devices.

### Description of Related Art Including Information Disclosed Under 37 CFR 1.97 and 1.98

Typical propulsion devices utilize electrical, mechanical, chemical, or some combination of electrical, mechanical, and/or chemical to generate a motive force to propel an object. One example is a typical motor vehicle, which relies on a combustion engine to propel the vehicle. Such vehicles also rely on a chemical reaction (combustion) to impart force on the pistons inside the engine to create a linear motion, which is translated to rotational motion of the vehicle's tires through a crankshaft and gearing arrangement. This rotational motion of the tires is translated back to linear motion of the vehicle due to action of friction between the tires and the surface with which they are in contact. Another example is a chemical rocket, which relies on the expulsion of high-velocity gas to create sufficient force to push the rocket along a desired path in a direction opposite that of the expelled gas. Modern airplanes and jets rely on these same principles. Jet engines combust fuel to expel a high-velocity gas rearward, thereby propelling the jet forward due to the rearward force of the expelled gas. Propeller-driven airplanes rely on a combustion engine or gas turbine to rotate the propeller, the angled blades of which impart a force on the air aft of the propeller, which generates a propulsive force in the opposite direction on the blade and, consequently, on the airplane to produce forward motion. Still, regardless of the type of propulsion device each operates under the principles of Newtonian Laws of Physics, which include the Laws of Motion, Properties of Inertia, Conservation of Energy and Conservation of Momentum:
a. Inertia=mass*radius\hat{ }2 (simplified as a point mass).
b. Conservation of angular momentum: L=Inertia*angular velocity (where L is a constant provided there is no external torque on the system)
c. Rotational energy=Inertia*angular velocity\hat{ }2
d. Linear Kinetic Energy=½*mass*velocity\hat{ }2.
   However, at the core is the basic law of Newtonian physics that for every action there is an equal and opposite reaction.

A tremendous disadvantage to such traditional propulsion devices is the requirement for friction and for large volumes of fuel for thermal chemical reactions. This introduces limitations in the sense that friction surfaces wear over time, which causes the friction coefficient to vary unpredictably, and the volume of fuel that is required is often so large that the payloads that may be supported is severely reduced. What is needed is a drive system that overcomes such limitations.

### BRIEF SUMMARY OF THE INVENTION

The present invention is drawn to a directional motive force generation device, the device comprising: a counter-rotating mass pair, each mass rotating about a fixed point in synchronization with the other mass; and an actuator associated with each mass, the actuator for varying the position of each mass relative to the respective axis to create a net resultant force for propulsion of the device. Additional embodiments of the invention feature added elements, including but not limited to: a drive gear attached to one mass and receiving rotational energy from an energetic drive means and a driven gear attached to the other mass, the driven gear receiving rotational energy from the drive gear; an energetic drive means for imparting rotational energy on the counter-rotating mass pair; an overrun means for allowing rotation of the mass pair independent of the energetic drive means when the speed of the mass pair exceeds the drive speed of the energetic drive means; an actuator sensor for each actuator and a trigger mechanism for synchronously triggering the actuator sensors to signal the actuator to alter the position of the associated mass; a trigger mechanism position is alterable to vary the actuator sensor trigger timing; a braking means for slowing the rotation of the counter-rotating mass pair; and a plurality of counter-rotating mass pairs, each mass rotating about a fixed point in synchronization with the other mass of the respective pair.

The present invention in another embodiment is drawn to a method for generating a directional motive force, the method steps comprising: imparting rotational energy on a pair of counter-rotating masses, each mass rotating about a fixed point in synchronization with the other mass; synchronously altering the radius of rotation of the mass pair to increase the angular velocity of the mass pair during a portion of the rotational period; and synchronously altering the radius of the rotation of the mass pair to decrease the angular velocity of the mass pair during the remaining portion of the rotational period. Additional embodiments of the invention feature added elements, including but not limited to: altering the position of a trigger mechanism to change the rotational period timing during which the angular velocity of the masses increases; changing the rotational period timing during which the angular velocity of the masses increases; exchanging the period during which the angular velocity of the mass pair increases with the period during which the angular velocity of the mass pair decreases to change the net resultant force; and exchanging the period during which the angular velocity of the mass pair increases with the period during which the angular velocity of the mass pair decreases to change the net resultant force.

Yet another embodiment of the present invention includes the method steps of: imparting rotational energy on a device comprising a plurality of pairs of counter-rotating masses, each pair comprising a mass rotating about a fixed point in synchronization with the other mass of the pair; synchronously altering the radius of rotation of the mass pairs to increase the angular velocity of the mass pairs during a portion of the rotational period; and synchronously altering the radius of the rotation of the mass pairs to decrease the angular velocity of the mass pairs during the remaining portion of the rotational period; wherein the alternating angular velocity creates a net resultant force for propulsion of the device. Additional embodiments of the invention feature added elements, including but not limited to: altering the position of a trigger mechanism to change the rotational period timing during which the angular velocity of the masses increases; changing the rotational period timing during which the angular velocity of the masses increases; exchanging the period during which the angular velocity of the mass pairs increases with the period during which the angular velocity of the mass pairs decreases to change the net resultant force; and exchanging the period during which the angular velocity of the mass pairs increases with the period during which the angular velocity of the mass pairs decreases to change the net resultant force.

### BRIEF DESCRIPTION OF THE SEVERAL VIEWS OF THE DRAWING(S)

The present invention will be more fully understood by reference to the following detailed description of the preferred embodiments of the present invention when read in conjunction with the accompanying drawings, wherein:

FIG. 1 presents a diagram depicting the effects of the energy state of a mass as its radius changes as it rotates about a center point;

FIG. 2 presents a diagram depicting the kinetic energy relative to the work done on the mass as it rotates about the center point;

FIG. 3 presents a diagram depicting the use of a secondary driven system that is synchronized with a primary driver system;

FIG. 4 presents a first embodiment of a reactionless drive motive force generation device as described herein;

FIG. 5 presents an exploded view of the primary drive mass and secondary driven mass highlighting their respective, synchronized orientations;

FIG. 6 presents an exploded view of the framework structure surrounding the primary drive mass and secondary driven mass;

FIG. 7 presents a partly assembled, partly exploded view of the embodiment highlighting attachment of the energetic drive means and optional braking means;

FIG. 8 presents an exploded view of the secondary driven mass and shaft assembly;

FIG. 9 presents the attachment of a power buss for energizing the actuator devices;

FIG. 10 presents the actuator trigger mechanism of the present embodiment;

FIG. 11 presents an alternate embodiment in which multiple driver/driven mass pairs are provided;

FIG. 12 presents a close-up view of the trigger mechanism in relation to the actuator sensors in a first position;

FIG. 13 presents a close-up view of the trigger mechanism in relation to the actuator sensors in a second position;

FIG. 14 present a close-up view of the trigger mechanism in relation to the actuator sensors in a third position;

FIG. 15 presents a first stage of the embodiment operation;

FIG. 16 presents a second stage of the embodiment operation;

FIG. 17 presents a third stage of the embodiment operation; and

FIG. 18 presents a fourth stage of the embodiment operation.

The above figures are provided for the purpose of illustration and description only, and are not intended to define the limits of the disclosed invention. Use of the same reference number in multiple figures is intended to designate the same or similar parts. Furthermore, when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the particular embodiment. The extension of the figures with respect to number, position, relationship, and dimensions of the parts to form the preferred embodiment will be explained or will be within the skill of the art after the following teachings of the present invention have been read and understood.

### DETAILED DESCRIPTION OF THE INVENTION

Reactionless drive systems, in general, provide the ability to apply force and to do work in free space absent of friction and without the need for thermal chemical reactions. The reactionless drive system device described herein presents a rotational system that does more work to one side of the rotational system than the other. This difference in work allows the device may apply a force to an external object.

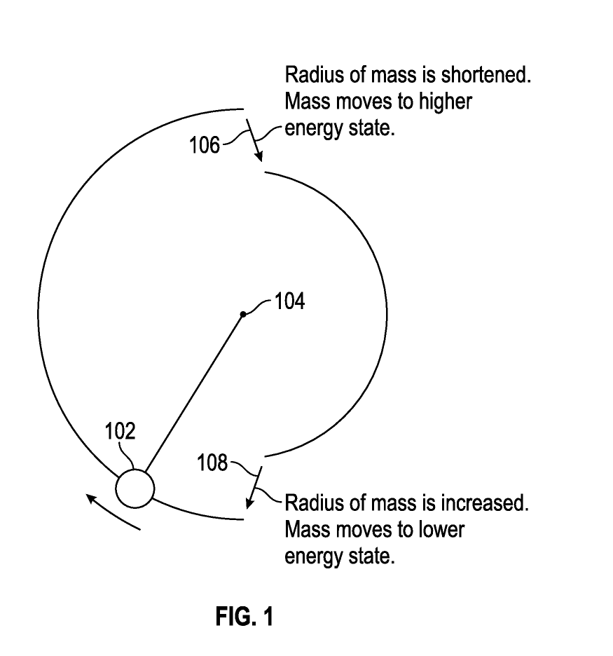

FIG. 1 presents a diagram depicting the effects of the energy state of a mass as its radius changes as it rotates about a center point. The mass (102) is rotated at angular velocity w at distance “r” from the axis (104). As the rotating mass is drawn closer to the axis of rotation without applying an external torque (106), its inertia is reduced which causes its angular velocity to increase according to conservation of angular momentum L=I*w. Conversely, as the rotating mass is allowed to return to its original radius (108) without applying an external torque, its inertia is increased which causes its angular velocity to decrease. Kinetic energy is determined by the formula Ke=½*Inertia*angular velocity \hat{ }2, which establishes that velocity is a square function while inertia is not. Therefore, the inverse linear function of the conservation of momentum formula dictates that the energy of the system increases as its inertia decreases provided that no external torque is applied.

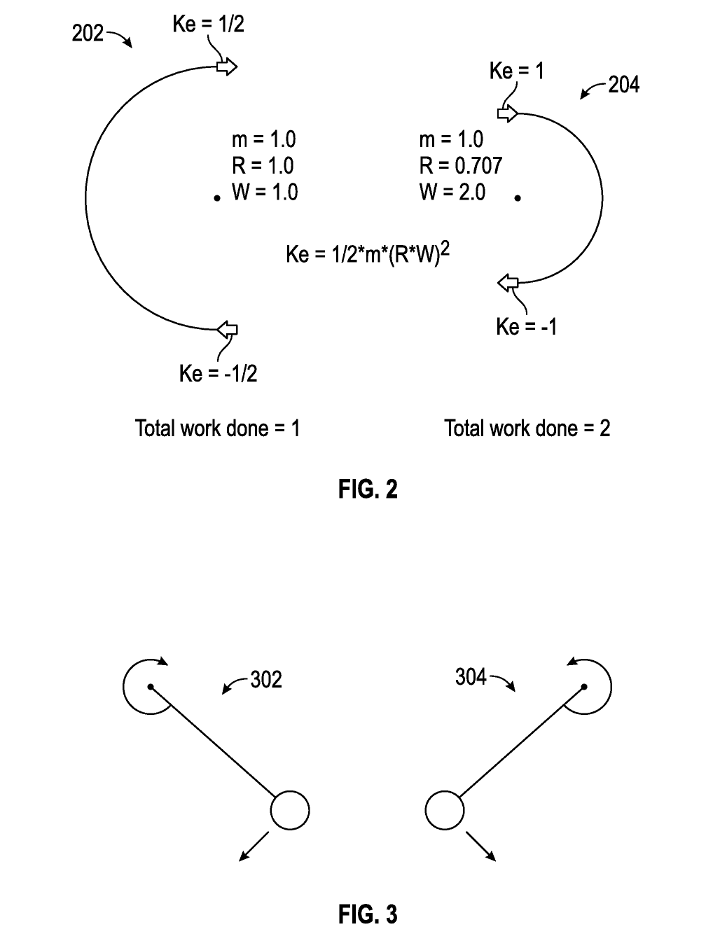

FIG. 2 presents a diagram depicting the kinetic energy relative to the work done on the mass as it rotates about the center point. In this example, mass (m) rotating clockwise at an angular velocity (ω) at distance (r) from the axis at the 6 o'clock position has an angular energy of ½*(m*r\hat{ }2)*(ω\hat{ }2). Assume mass=1, ω=1 and r=1, which gives it an instantaneous linear energy of ½*m*(ω*r)\hat{ }2 or ½ (units omitted). If the mass rotates 180 degrees to the 12 o'clock position the work done is twice the initial kinetic energy of the mass or 1, since the mass will travel at the same velocity in the opposite direction: ½−(−)½=1 (202).

Consider now that at the 12 o'clock position work is done to the mass to pull it in towards the axis to a radius of 0.707, which effectively cuts the Inertia in half. Given the formula I=m*r\hat{ }2, the square of 0.707 is 0.5. This results in an increase in angular velocity of 100% to 2 from the conservation of angular momentum formula: L=I*w. Therefore, in this section of the rotation the mass=1, ω=2 and r=0.707, giving an instantaneous linear energy of ½*m*(o)*r)\hat{ }2 or 1 (units omitted). If the mass rotates 180 degrees to the 6 o'clock position the work done is twice the kinetic energy of the mass at 12 o'clock or 2, since the mass will travel at the same velocity in the opposite direction: −1(−)1=−2 (204). When the mass returns to the 6 o'clock position again the mass is moved back to radius r, then the energy level of the system is again returned to its original levels the cycle may repeat.

FIG. 3 presents a diagram depicting the use of a secondary driven system that is synchronized with a primary driver system. As a means to eliminate the forces of acceleration throughout the rotation of the primary drive mass and isolate the intended directional force vector, the secondary driven system (304) is synchronized with the primary driver system (302) traveling in opposite rotational direction so that the unnecessary force components are cancelled out and furthermore, so that the reactionary force present to pull the masses towards and push them away from the axis of rotation are cancelled out.

As the masses rotate faster to achieve higher output, the triggers that activate the actuators maybe be rotated or advanced using a timing mechanism that incorporates a cam and follower much like a traditional automotive ignition system. This allows the masses to reach their desired energy levels before they enter the opposite semicircle of the rotation. Thus, the two rotational paired masses provide work in a specific direction overall (a resultant net force vector). However, while the resultant net force vector is useful work in a specific direction the pulse output might be undesirable depending on the application. Any undesirable pulse output may be effectively minimized through the utilization of additional paired masses (i.e., additional paired primary driver/secondary driven systems), each pair of which rotates out of phase with each other pair. The greater the number of paired masses, each rotating out of phase with the others, the more the pulse output is minimized.

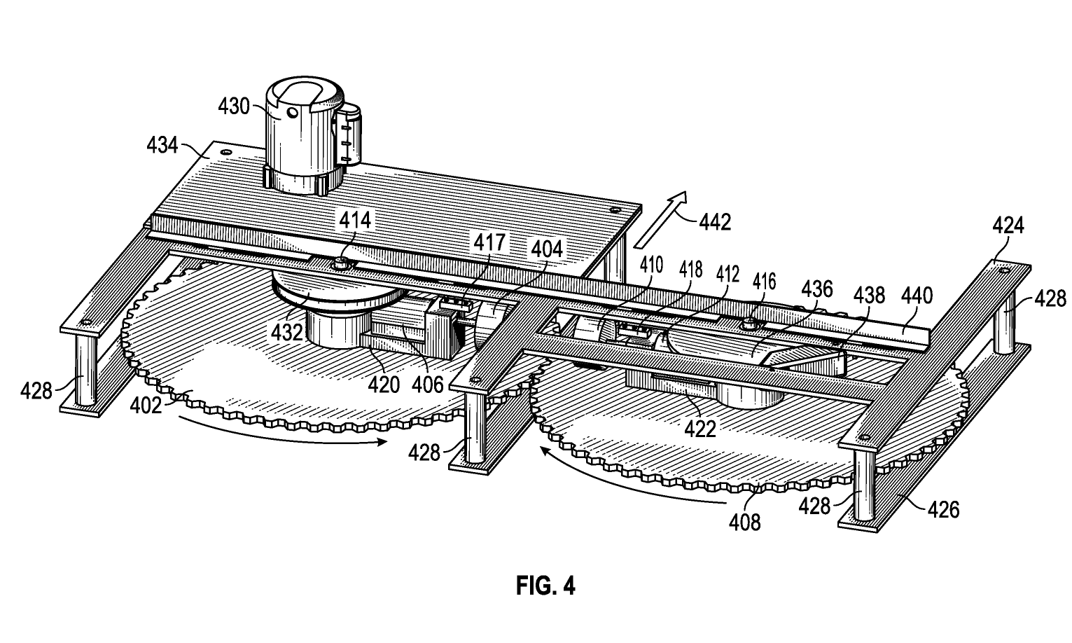

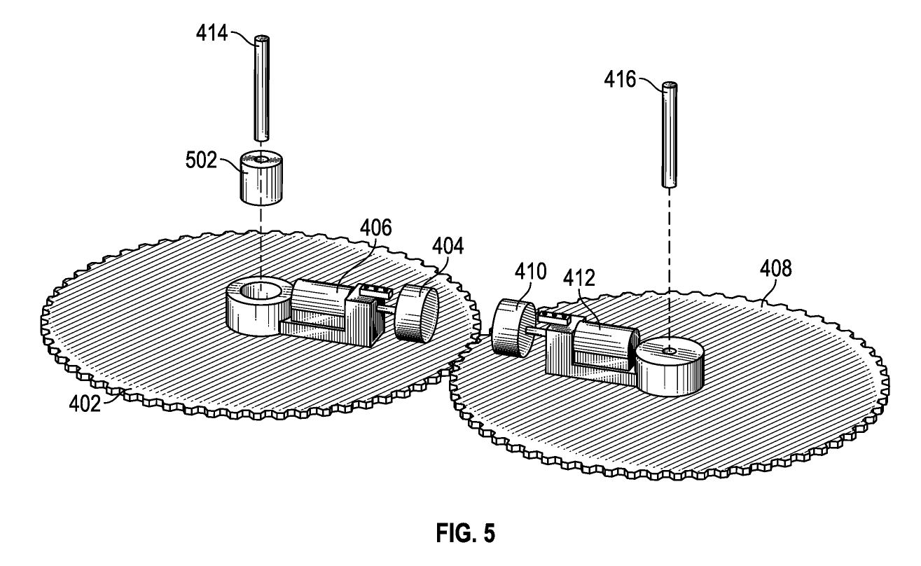

FIG. 4 presents an assembled view of a first embodiment of a reactionless drive motive force generation device as described herein. The various components are highlighted in exploded views of the embodiment found in FIGS. 5 to 10. The embodied device generally includes rotating masses (404 and 410) and an actuator means (406 and 412, respectively) associated with each mass, for varying the radius, or distance of the masses from the axis (414 and 416, respectively). The present embodiment utilizes an electrical solenoid receiving its power inductively or through slip rings oriented about the axis, with timing pulses provided based on a trigger device (440) and the rotation of the gears (402 and 408). The actuators (406 and 412) move the masses (404 and 410, respectively) towards or away from the axis in a slidable manner that does not apply external torque to the system, thereby varying the radius of each mass (404 and 410) from the respective axis. The actuators (406 and 412) may be located in-line with the travel path of the masses (404 and 410, respectively) or in other embodiments may be oriented remotely and out of line with the line of travel of the masses (404 and 410, respectively), each transmitting force through a mechanical or magnetic linkage means. One of ordinary skill in the art will understand and appreciate that other embodiments may utilize pneumatic, electric, magnetic, mechanical actuators, or some combination of the like, and may utilize programmable logic controllers or other programmable devices capable of actuating the masses in relation to angular rotation. The implementation of such actuators is within the skill of one having ordinary skill in the art to which the invention pertains. A bracket (420 and 422) is also utilized to support and/or guide the masses (404 and 410, respectively) as they are driven about the axis and moved towards and away from the axis.

The motive force generation device embodiment also includes a synchronization means (402 and 408) to synchronize the primary drive mass and secondary driven masses (404 and 410, respectively). This synchronization means of the present embodiment is formed from the mechanical linkage of gears as depicted, but may be in any mechanical linkage form including gears, timing belts, or some combination that ensures the masses are rotating in opposite directions about the axis (414 and 416) and in line with one another. The secondary driven mass (410) is positioned at a negative of the angle of the primary driver mass (404) to an imaginary line tangential to the two paths of travel of both masses (404 and 410). FIG. 5 presents an exploded view of the primary drive mass and secondary driven mass highlighting their respective, synchronized orientations. Visible in this figure is the overrun means (502) that allows the masses (404 and 410) to run faster than the driven input shaft (414) when the energy level of each mass is raised by moving the mass closer to the axis (414 and 416). This overrun means includes, but is not limited to, over-running clutches, mechanical sprag clutches, one-direction bearings, and some combination of same, or other such means commonly known in the mechanical arts.

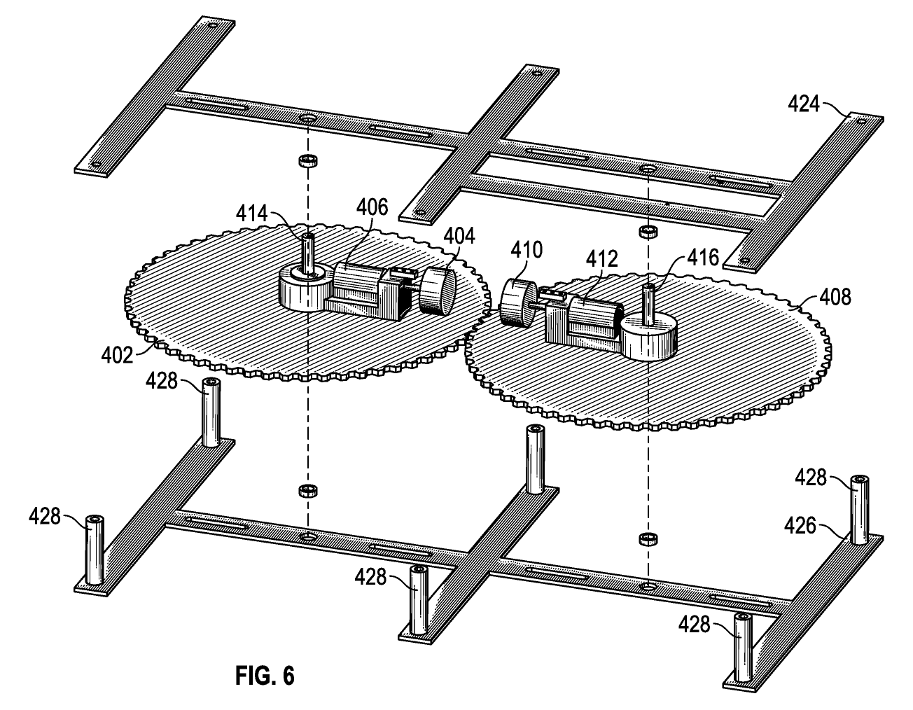

FIG. 6 presents an exploded view of the framework structure surrounding the primary drive mass and secondary driven mass. As depicted, the drive embodiment includes shafts (414 and 416) to support the rotating masses that are positioned within the framework (424 and 426) via sleeved bearings. Standoffs (428) maintain proper spacing of the framework to allow for rotation of the masses to occur without undue movement of the components relative to one another. Also, the assembled framework (424/426) provides a mounting point to allow the device to transfer its motive force to a larger assembly.

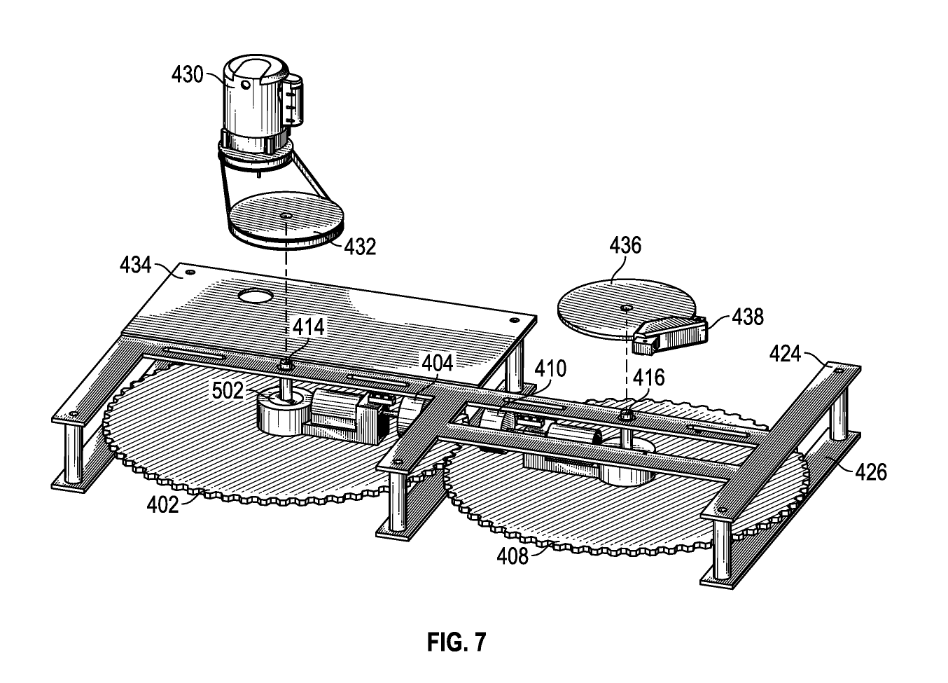

FIG. 7 presents a partly assembled, partly exploded view of the embodiment highlighting attachment of the energetic drive means and optional braking means. The embodiment shown utilizes a conventional electric motor as the energetic drive means, but may utilize such other energetic drive means capable of producing axial rotation of a pulley (432) attached to the input shaft (414). One of ordinary skill in the art will understand and appreciate that alternatives may be used as a drive means to input energy into the system. For example, a flexible coupling or direct-drive shaft may be used in place of the depicted pulley driven system. The energetic drive means is fixed positionally to the system through hard mounting (434) or other conventional attachment means. The driven shaft (414) attaches to the overrun means (502) to transfer input energy to the drive (402) and driven (408) gears, which transfers to the masses (404 and 410).

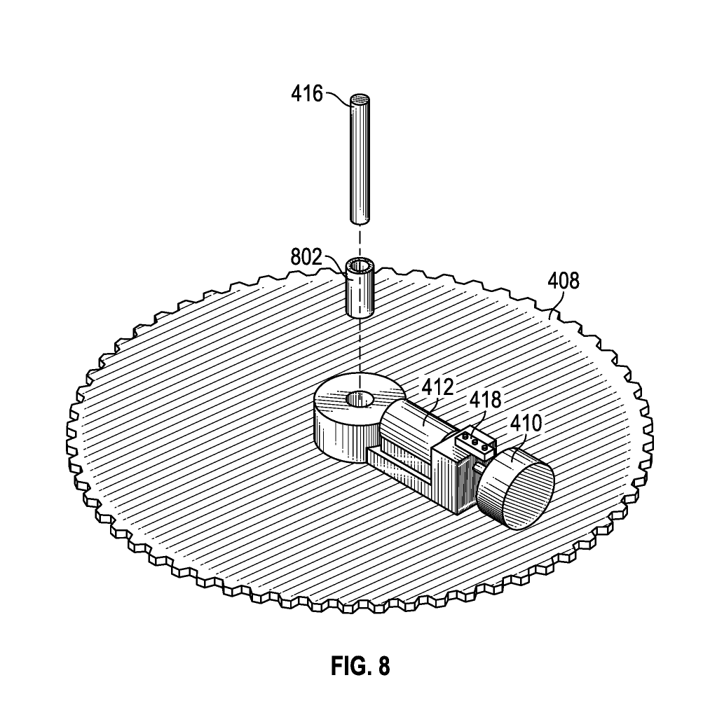

FIG. 8 presents an exploded view of the secondary driven mass and shaft assembly. As depicted, the axle shaft (416) may be fixed to the mass or allowed to free spin via a bearing (802) depending on the application. For example, in applications that require a braking force the axle may be fixed to the mass to provide a mounting point for a brake rotor or similar braking apparatus (27). Referring once more to FIG. 7, the braking apparatus is shown as a brake rotor (436) and caliper (438) having friction pads that contact the brake rotor. Actuation means for the brake caliper include hydraulic (for example—as in automotive applications), electric, or pneumatic. Also envisioned are electromagnetic braking means, for example, that utilize the electromagnetic forces of a generator to slow the masses rotation. Such electromagnetic forces may also be utilized to produce electricity, for example, as in the well-known regenerative braking system in use on modern electric automobiles.

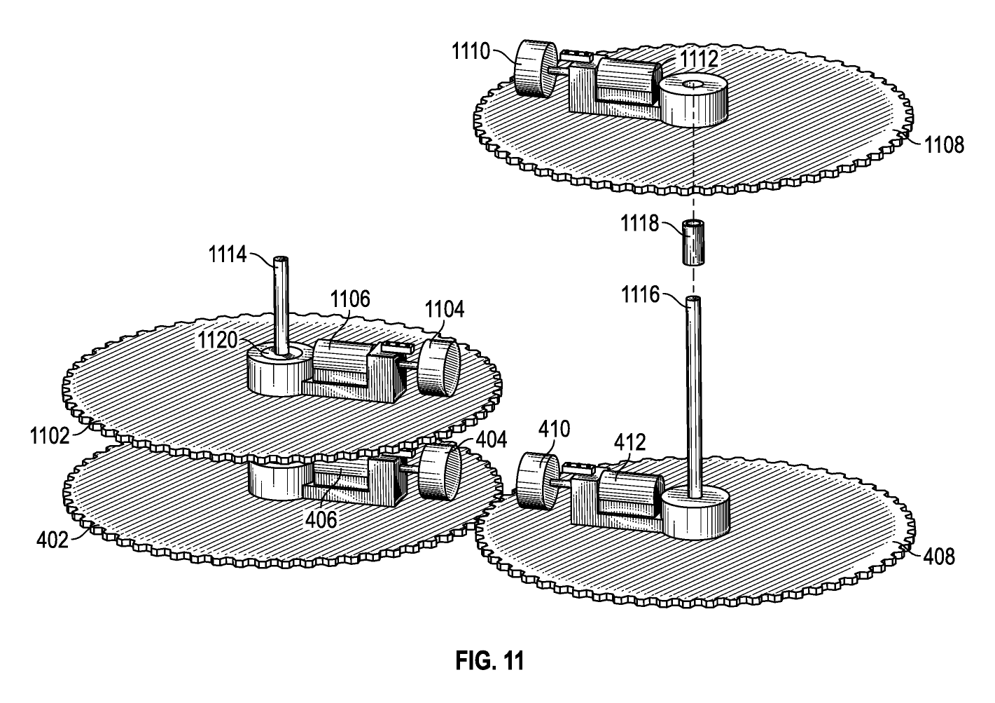

In applications that do not require a braking force the shaft may be mounted to the mass with a bearing (802) so that the driven mass may turn independently of the shaft. For example, several driven masses may be mounted to a single shaft with corresponding driving masses on the input shaft. FIG. 11 presents an alternate embodiment in which multiple drive/driven mass pairs are provided. As depicted in this figure, a matching drive gear (1102), actuator (1106), and mass (1104) is “stacked” upon an extended drive axle (1114), with power transmitted from the axle through a matching overrun means (1120). Likewise, a matching secondary driven gear (1108), actuator (1112), and mass (1110) are “stacked” upon an extended axle shaft (1116) with bearing (1118). Other embodiments may include additional pairs of drive/driven masses, the effect of which, as previously stated, reduces output pulsing that may occur.

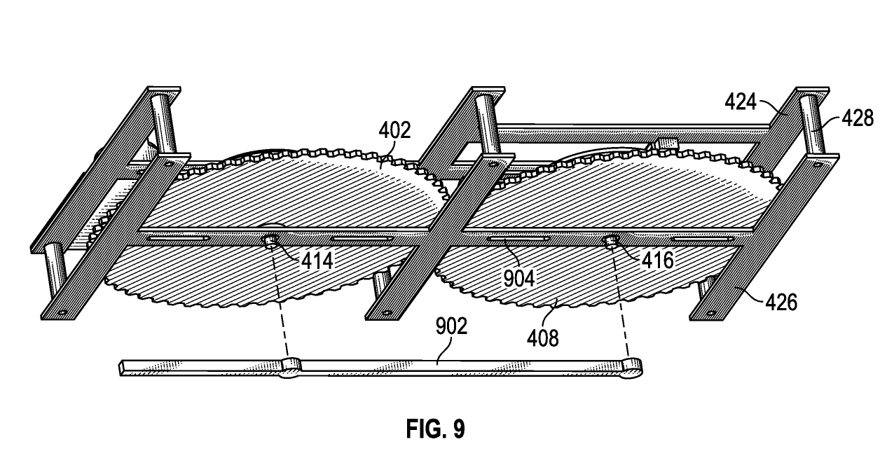

FIG. 9 presents the attachment of a power buss for energizing the actuator devices. As depicted, electrical wires or busses are provided (902) to provide energy via slip rings or conductors embedded in the axles (414 and 416). An external battery or other source of energy transfers electrical power to the actuators via this path. In other embodiments that utilize pneumatic or hydraulic controls, appropriate plumbing may be utilized with rotary couplings at the axle interfaces. Such energization means are well known and need not be discussed herein.

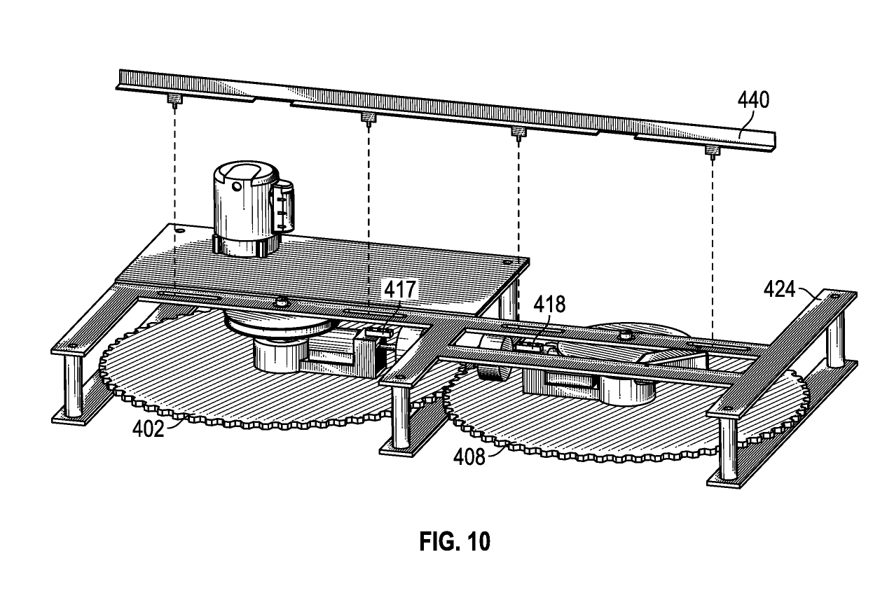

FIG. 10 presents the actuator trigger mechanism of the present embodiment. As depicted, the trigger mechanism (440) interacts with the actuator sensors in a timed fashion to cause the actuators to move the masses towards or away from the axis of rotation, thereby raising and lowering each mass' energetic state. The triggers may be mounted either on the rotating masses, any of its supporting components or on the frame (424) as depicted.

In this embodiment a selector linkage activates the trigger mechanism (440) to cause it to move to a desired position relative to the actuator sensors (417 and 418). The actuator sensor means may be mechanical, magnetic, photo, electrical or any other well-known and understood means. For example, in the present embodiment the device utilizes hall-effect sensors that detect the position of the trigger mechanism (440) with respect to the actuator sensor (417 and 418). In other embodiments the trigger mechanism (440) may be fixed in relation to the frame or may be movable to change behavior of the drive dependent on the device operational state.

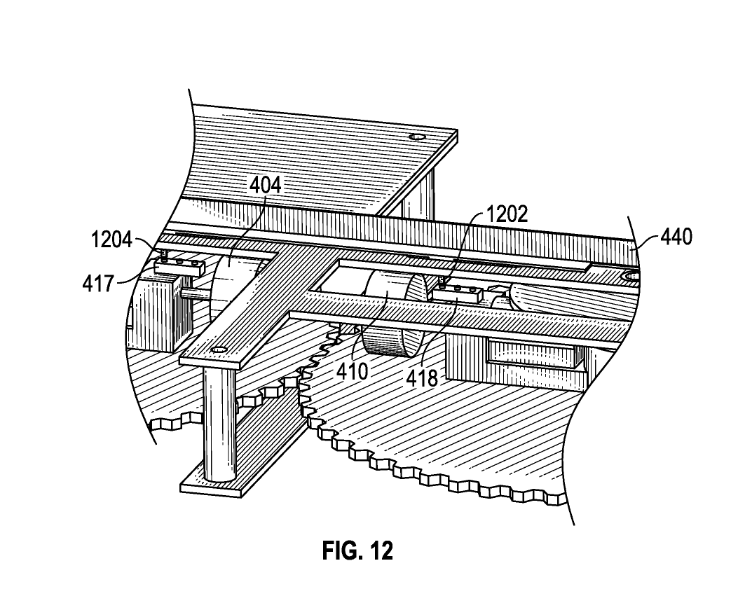

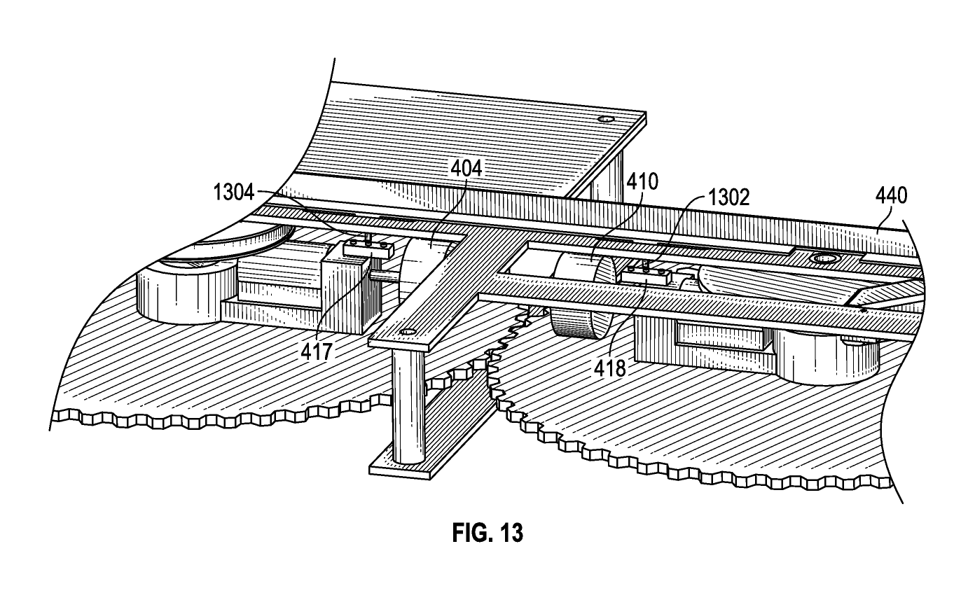

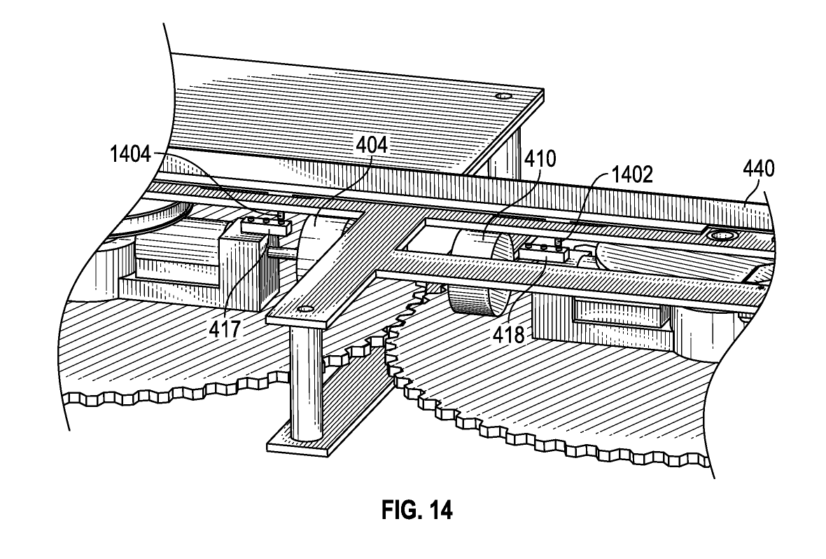

The selector in its basic form interacts with the actuator sensors (417 and 418) to activate each actuator to pull the respective mass in towards the axis of rotation at a preset angle of rotation, and then returns each mass to the initial position at another present angle of rotation. The trigger mechanism (440) position may adjust or advance the timing of this signal mechanically or electronically based on the rotational speed of the masses by utilizing a positioning means to change the state based on user input. FIGS. 12, 13, and 14 present a close-up view of the trigger mechanism in relation to the actuator sensors, with a different position depicted in each. For example, in FIG. 12 the trigger mechanism (440) is positioned to the left. The mass (404) on the left has its actuator sensor (417) inside trigger activated in this position (1204) but has its outside trigger activated when it is 180 degrees from this position. This can be used to provide net resultant trust in a particular direction. In FIG. 13 the trigger mechanism (440) activates the actuator sensor (417) center trigger (1304) on both this position and at 180 degrees from this position. This is a neutral drive providing net resultant trust in neither direction. Likewise, in FIG. 14 the trigger mechanism (440) activates the actuator sensor (417) outside trigger (1404) in this position and the inside trigger at 180 degrees to this position, providing a net resultant thrust in a direction opposite that of FIG. 12. This may be useful as a braking trust or reverse mode if the application requires it.

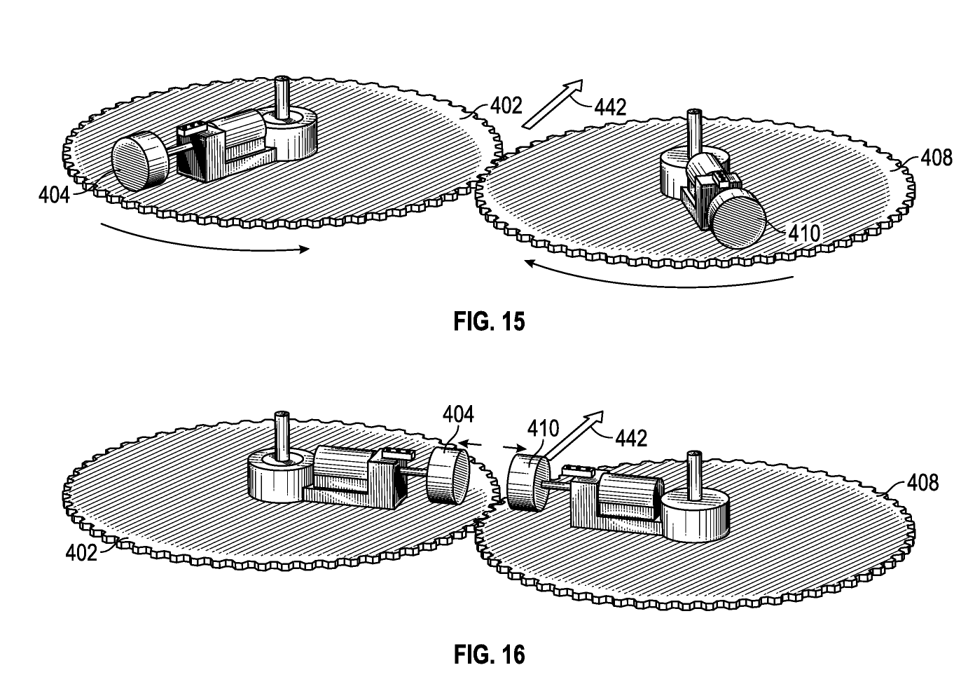

FIGS. 15, 16, 17, and 18 present different stages of the drive operation. In the first operational stage of FIG. 15, each synchronized mass (404 and 410) is at its furthest point from the axis and is driven rotationally by the energetic drive means input, which adds energy to the system and which overcomes the frictional forces on the system or adds energy to the mass as required by the application or physical demands on the system. In this stage the overrun means is engaged with the shaft and transmitting power to the driver mass (404). The driven mass (410) is being driven by the driver mass system such that its velocity is equal in the opposite direction of rotation. During this stage the velocity of the mass is changed 180 to its initial velocity. In other words, work is done to the mass.

In the second operational stage of FIG. 16, each actuator is triggered and the attached masses (404 and 410) are moved inward towards the axis of rotation, thereby decreasing their moment of inertia and increasing their angular velocity and energy state.

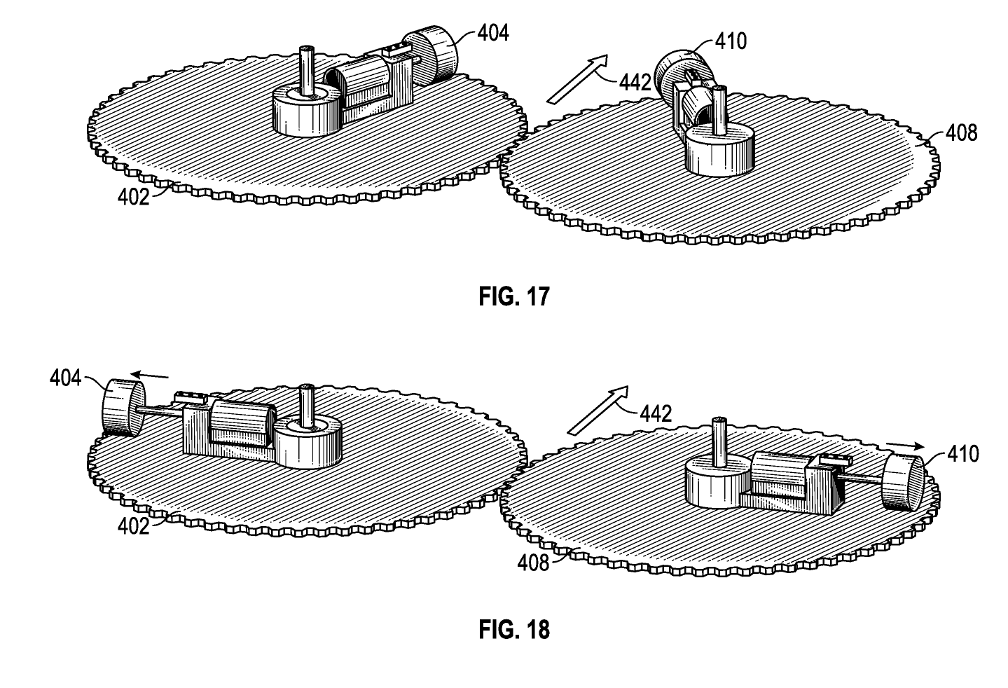

In the third operational stage of FIG. 17, the masses (404 and 410) in the elevated state of energy rotate faster about the axis than in the first stage (FIG. 15). The presence of the overrun means allows the mass to rotate faster due to the action of the overrun means, lest the energetic drive means introduce resistance to rotation. During this third stage the velocity of the mass is reversed and the mass exits the stage at a negative velocity of that which it enters, minus any losses for friction.

In the fourth operational stage of FIG. 18, the actuators are triggered and each mass is moved outward, lengthening the radius and returning each to its lower energetic level, or its furthest position from the axis of rotation (decreasing increasing their moment of inertia and decreasing their velocity). The masses slow to the original velocity of stage one, minus losses due to friction etc., and the input shaft again engages the rotating mass such that the energetic drive means is allowed to add rotational energy to compensate for losses. These four stages repeat for as long as the output requirement is maintained. It is the difference in change of direction and initial energy level between stages one and three that produce the unbalanced mass to create a net resultant force vector (442) to provide reactionless propulsion.

The invention may be embodied in other specific forms without departing from the spirit or essential characteristics thereof. The present embodiments are therefore to be considered in all respects as illustrative and not restrictive. Accordingly, the scope of the invention is established by the appended claims rather than by the foregoing description. All changes that come within the meaning and range of equivalency of the claims are intended to be embraced therein. Further, the recitation of method steps does not denote a particular sequence for execution of the steps. Such method steps may therefore be performed in a sequence other than that recited unless the particular claim expressly states otherwise.

I claim:

1. A directional motive force generation device, the device comprising:
a counter-rotating mass pair, the mass pair comprising a drive mass rotating about a fixed point defined by a first shaft and a driven mass rotating about a fixed point defined by a second shaft in a direction opposite that of the drive mass and in synchronization with the drive mass; and
an dedicated actuator associated with each mass, each actuator adapted to cause the creation of a net resultant force for propulsion of the device by varying the distance of the respective mass relative to the respective axis during rotation of the counter-rotating mass pair.

2. The device of claim 1 further comprising:
a drive gear attached to the drive mass and receiving rotational energy from an energetic drive means; and
a driven gear attached to the driven mass, the driven gear receiving rotational energy from the drive gear.

3. The device of claim 1, the device further comprising:
an energetic drive means for imparting rotational energy on the counter-rotating mass pair.

4. The device of claim 3, the device further comprising:
an overrun means for allowing rotation of the counter-rotating mass pair independent of the energetic drive means when the speed of the mass pair exceeds the drive speed of the energetic drive means.

5. The device of claim 1 further comprising:
an actuator sensor for each actuator and a trigger mechanism for synchronously triggering the actuator sensors to signal the actuator to alter the position of the associated mass.

6. The device of claim 5 wherein the trigger mechanism position is alterable to vary the actuator sensor trigger timing.

7. The device of claim 1 further comprising:
a braking means for slowing the rotation of the counter-rotating mass pair.

8. The device of claim 1, the device further comprising:
a plurality of counter-rotating mass pairs.

9. A method for generating a directional motive force, the method steps comprising:
imparting rotational energy on a device comprising at least one pair of counter-rotating masses, each pair comprising a drive mass rotating about a fixed point defined by a first shaft and a driven mass rotating about a fixed point defined by a second shaft in a direction opposite that of the drive mass and in synchronization with the drive mass;
synchronously altering the radius of rotation of the mass pair to increase the angular velocity of the counter-rotating mass pair during a portion of the rotational period; and
creating a net resultant force for propulsion of the device by synchronously altering the radius of the rotation of the counter-rotating mass pair to decrease the angular velocity of the counter-rotating mass pair during the remaining portion of the rotational period.

10. The method of claim 9, the method steps comprising:
altering the position of a trigger mechanism to change the rotational period timing during which the angular velocity of the pair of masses increases.

11. The method of claim 9, the method steps comprising:
changing the rotational period timing during which the angular velocity of the pair of masses increases.

12. The method of claim 9, the method steps comprising:
exchanging the period during which the angular velocity of the counter-rotating mass pair increases with the period during which the angular velocity of the counter-rotating mass pair decreases to change the net resultant force.

13. The method of claim 9, the method steps comprising:
exchanging the period during which the angular velocity of the counter-rotating mass pair increases with the period during which the angular velocity of the counter-rotating mass pair decreases to change the net resultant force.

14. A method for generating a directional motive force, the method steps comprising:
imparting rotational energy on a device comprising a plurality of pairs of counter-rotating masses, each pair comprising a drive mass rotating about a fixed point defined by a first shaft and a driven mass rotating about a fixed point defined by a second shaft in a direction opposite that of the drive mass and in synchronization with the drive mass;
synchronously altering the radius of rotation of the counter-rotating mass pairs to increase the angular velocity of the counter-rotating mass pairs during a portion of the rotational period; and
creating a net resultant force for propulsion of the device by synchronously altering the radius of the rotation of the counter-rotating mass pairs to decrease the angular velocity of the counter-rotating mass pairs during the remaining portion of the rotational period.

15. The method of claim 14, the method steps comprising:
altering the position of a trigger mechanism to change the rotational period timing during which the angular velocity of the counter-rotating masses increases.

16. The method of claim 14, the method steps comprising:
changing the rotational period timing during which the angular velocity of the counter-rotating masses increases.

17. The method of claim 14, the method steps comprising:
exchanging the period during which the angular velocity of the counter-rotating mass pairs increases with the period during which the angular velocity of the counter-rotating mass pairs decreases to change the net resultant force.

18. The method of claim 14, the method steps comprising:
exchanging the period during which the angular velocity of the counter-rotating mass pairs increases with the period during which the angular velocity of the counter-rotating mass pairs decreases to change the net resultant force.
